(19) United States
(12) Patent Application Publication
(10) Pub. No.: US 2015/0278794 A1
(43) Pub. Date: Oct. 1, 2015

(54) SPLIT PAYMENT METHOD AND SYSTEM FOR A PRODUCT OR SERVICE

(71) Applicant: David Haddad, Paris (FR)

(72) Inventor: David Haddad, Paris (FR)

(21) Appl. No.: 14/665,327

(22) Filed: Mar. 23, 2015

(30) Foreign Application Priority Data
Mar. 25, 2014 (FR) 1452493

(51) Int. Cl. G06Q 20/22; G06Q 20/40

(52) U.S. Cl. CPC G06Q 20/29; G06Q 20/405

(57) ABSTRACT

This payment system for a product or service, for the payment for a product or service by a number of settlements, comprises a payment module accessible to one or more purchasers via a telecommunication network to allow said purchaser to select the product or service and transmit to said module information relating to the split payment for the product or service comprising the number of settlements and the indication of the buyer or each buyer. The payment module also comprises means for sending, to the buyer or each buyer, an electronic message containing bills for the execution of each settlement generated by the payment module.

### PRIORITY CLAIM

This application claims priority to French Patent Application No. FR 1452493 entitled filed Mar. 25, 2015, which is incorporated herein by reference in its entirety.

### BACKGROUND OF THE INVENTION

1. Field of the Invention

The invention relates generally, to the online payment for products or services. The invention relates, more particularly, to the online payment for tickets, such as airplane tickets.

2. Description of the Relevant Art

When ordering a product or service, and notably ordering a ticket, the provision of the ticket takes place only after full settlement of its price.

The intermediaries who provide the interface between a client and the third party service provider, for example an airline, only authorize the delivery of the ordered ticket after full settlement of the price.

However, in some cases, it may be that the products or services are the subject of a grouped order for a number of people who want to benefit therefrom together, that is to say on behalf of a number of end users. It may also be that a buyer wants to settle the asking price by a number of settlements.

Thus, it may be that the purchase is made for one or more buyers who each want to settle by one or more settlements.

In the context of a grouped purchase, it is of course possible for one of the buyers, who places the order for all the goods or services, to settle the amount for all of the products ordered, the other buyers then being responsible for reimbursing the buyer who advanced the funds. As can be imagined, this solution requires cash advance. It can also pose payment means ceiling problems, which can thus prevent the sale and also pose problems of assurance with respect to the other buyers.

Obviously, another solution consists in allowing each buyer to order and settle separately for the products or services, which can then pose problems of product availability, of price variations or of ordering errors, for example flight number errors.

### SUMMARY OF THE INVENTION

The aim of the invention is therefore to mitigate these various drawbacks and allow for a split payment for a product or service, that is to say a payment by a number of settlements, and do so from a single grouped order while mitigating the abovementioned drawbacks.

A first embodiment relates to a payment system for a product or service, for payment for a product or service by a number of settlements.

According to one embodiment, this system includes a payment module accessible to one or more purchasers via a telecommunication network to enable said purchaser to select the product or service and transmit to said module information relating to the split payment for the product or service, the information including the number of settlements and the indication of the buyer or of each buyer.

The payment module further comprises a transmittal device which sends, to the buyer or to each buyer, an electronic message containing rules for the execution of each settlement generated by the payment module.

By virtue of such a payment system which includes such a payment module, it is possible to allow a first buyer to reserve a set of products or services, the other buyers automatically receiving a message containing the rules of execution to be followed for each of these buyers to proceed with the settlement of the fraction of the price that he or she owes.

According to another feature of the payment system, the payment module includes a communication device that communicates with the vendor or the provider of the product or service to transmit thereto an order to deliver the product or service after each settlement has been made according to said rules of execution.

For example, the rules of execution may include the number of settlements and/or the settlement lead times.

According to yet another embodiment, the payment module communicates via a telecommunication network with an electronic reservation management platform which receives the statement of the stock of products or services available and which ensures the reservation of a product or service.

Thus, when the payment module is compatible with such an electronic reservation management platform or “GDS”, the payment system is particularly well suited to the reservation and the split payment for tickets and, in particular, airplane tickets.

The payment module can moreover include an order number generator which generates an order number for each settlement, said order number being transmitted together with said rules of execution.

In one embodiment, the payment module includes an order checking stage acting on the electronic reservation management platform to modify a reservation according to the execution of the settlements according to the rules of execution.

The payment module can moreover include means for provoking the display of a link to an online payment site on a screen accessible to each buyer, together with the message containing the rules of execution.

In one embodiment, the payment system includes a collection device that collects the settlements and makes an overall settlement for the product or service to the vendor or provider.

In another embodiment, is directed to a payment method for a product or service, for the payment of a product or service, by a number of settlements, for the implementation of a system as defined above.

This method includes the following steps:
selection by a purchaser of a product or service and transmission, to the payment module of the system, of information relating to the split payment for the product or service comprising the number of settlements planned for the payment for said product or service and the indication of the or each buyer; and
transmission, to each buyer, of an electronic message containing rules for the execution of each settlement generated by the payment module.

In a particularly advantageous application, this method is applied to the payment for a ticket.

### BRIEF DESCRIPTION OF THE DRAWINGS

Other aims, features and advantages of the invention will become apparent on reading the following description, given purely as a non-limiting example and with reference to the attached drawings in which:

FIG. 1 is a block diagram of a product or service reservation system comprising a payment system according to the invention; and

FIG. 2 shows a product or service reservation system comprising a variant embodiment of a payment system according to the invention.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

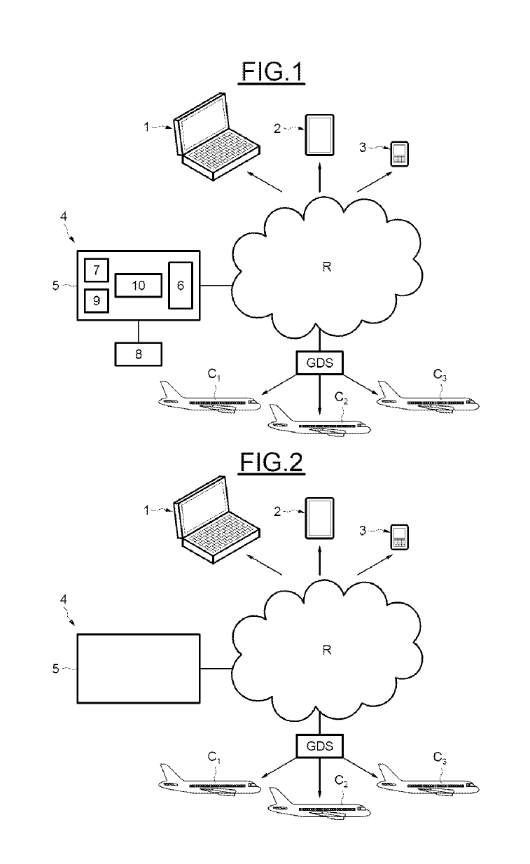

Reference will be made first to FIG. 1 which shows an online product or service reservation system according to a first embodiment.

In the exemplary embodiment illustrated, the reservation system is used for the online reservation of an airplane ticket with different airlines C1, C2 and C3.

Obviously, there is no departure from the framework of the invention when the object is to reserve and pay for other types of products or services, for example other types of tickets, or to reserve a complete trip, including a hotel reservation, or even proceed to reserve or pay for a physical product.

As can be seen, the reservation is made here via a computer reservation platform that includes an electronic reservation management platform or GDS, which stands for “Global Distribution System”.

This GDS platform is accessible to the client via a telecommunication network R, in this case the Internet network, by means of remote terminals, such as a computer 1, a touch tablet 2 or a mobile telephone 3.

As can be seen, this reservation system is also provided with a payment system that includes a payment module accessible to the users by means of the remote terminals 1, 2, 3. This reservation system is, for example, implemented by a server connected to the network R and includes all the hardware and software means enabling it to communicate with the GDS platform.

For this, the payment module 5 is provided with an interface 6 making it possible to ensure its connection to the telecommunication network R.

The payment module 5 enables the users to look up the statement of the available stock in the GDS platform to reserve one or more products or services.

As indicated previously, the aim is, for example to reserve a ticket, in this case an airplane ticket, offered by the airlines C1, C2, C3 and to allow for a split payment for the ticket by a number of settlements.

The object is either to allow one buyer to pay for his or her ticket by a number of settlements, or to allow a number of buyers to pay their particular share of the total price.

In one implementation, a first buyer accesses the payment system to obtain the indication of the flights offered by the airlines C1, C2 or C3. After having selected a set of tickets for a corresponding set of passengers, he or she sends to the processing module information relating to the split payment for the tickets.

For this, the payment module provokes the display on the screen of the terminal of the buyer who makes the reservation, of windows in which to enter this information.

The object is to input information making it possible to identify each buyer and to input the number of settlements planned.

Obviously, it can also simply be a matter of inputting information making it possible to identify each buyer, the payment module being responsible for computing the value of each settlement which will have to be acknowledged by each buyer.

The information input by the first buyer notably comprises the electronic address of each buyer. Thus, the payment module 5 includes a transmittal device 7 making it possible to address to each buyer an electronic message intended for each buyer containing the rules for the execution of each settlement. Obviously, a single buyer may be involved in the reservation, when the aim is simply to allow a payment for a ticket by a single buyer by a number of settlements.

These rules of execution are generated by the payment module 5. They concern the amount of each settlement and, optionally, a settlement limit date. This limit date can, for example, be determined by default and be modifiable.

The message transmitted to each buyer is, for example, an email and advantageously incorporates a link to the electronic address of an online payment website 8.

The buyers who receive this electronic message must therefore, before the expiry of the payment limit date, log onto the payment site 8 to proceed with the settlement.

It will moreover be noted that the payment module 5 incorporates a stage 9 ensuring the generation of an order number inserted into each message transmitted to the buyers in order to make it possible to identify the settlement.

It can moreover be seen in FIG. 1 that the payment module 5 further incorporates a stage 10 for checking orders which, for example, communicates with the payment site 8 to check the correct execution of the payment rules and, notably, that each payment has indeed been made within the lead times and with a correct amount.

This order checking stage 10 also communicates via the interface 6 with the GDS platform to transmit to it an order to deliver the tickets when the settlements have been made by the predefined rules of execution.

For example, the tickets are delivered only when all the settlements have been made. If such is not the case, the checking stage 10 can be configured to act on the platform to modify the orders in such a way as to either divide up one or more payments that have not been made between the remaining buyers, or to cancel the ticket or tickets for which a settlement has not been made.

Similarly, the online payment site, which may consist of a banking establishment site, can send to the payment module 5 an agreement message. In this case, the corresponding ticket is sent. In the case of rejection by the bank, the file may be cancelled or, when it is a refusal from the banking establishment only with regard to one or more passengers, a ticket may be sent only to the passenger or passengers who have acknowledged the due payment, the file being cancelled for the passengers who have not made the settlement.

In the embodiment of FIG. 1, the payment module 5 communicates with the payment site 8.

It is also possible, as a variant, as illustrated in FIG. 2, to provide an embodiment in which the payment module 5 is capable of collecting the payments made by the buyers and ensure the total settlement of the order with the airline or an intermediary.

In this case, the payment system has all the banking accreditations enabling it to see funds. For example an account number will be able to be created for each buyer and a virtual card number will be able to be generated and addressed to each buyer as soon as payment is validated.

It will be noted, finally, that, in the embodiments envisaged, the terminals that can be manipulated by the user for the use of the payment system can be of various kinds, which communicate via the telecommunication network R with the payment system posted in a remote server.

It will nevertheless be noted that the system and method which have just been described can also be implemented in the form of a software application which can be downloaded and be installed in the terminal that can be handled by the users.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A payment system for the payment of a product or service by a number of settlements, comprising:
a payment module accessible to one or more purchasers via a telecommunication network to enable said purchaser to select the product or service and transmit to said module information relating to the split payment for the product or service, the information comprising the number of settlements and the indication of the buyer or of each buyer, the payment module comprising a transmittal device which sends, to the buyer or to each buyer, an electronic message containing rules for the execution of each settlement generated by the payment module during use.

2. The payment system according to claim 1, wherein the payment module further comprises a communication device that communicates with the vendors or the provider of the product or service to transmit thereto an order to deliver the product or service after each settlement has been made according to said rules of execution.

3. The payment system according to claim 1, wherein the rules of execution comprise the number of settlements.

4. The payment system according to claim 1, wherein the rules of execution comprise a settlement lead time.

5. The payment system according to claim 1, wherein the payment module communicates via a telecommunication network with an electronic reservation management platform which receives a statement of the stock of products or services available and which ensures the reservation of a product or service.

6. The payment system according to claim 5, wherein the payment module further comprises an order checking stage acting on the electronic reservation management platform to modify a reservation according to the execution of the settlements according to the rules of execution.

7. The payment system according to any one of claim 1, wherein the payment module further comprises an order number generator that generates an order number for each settlement, said order number being transmitted together with said rules of execution.

8. The payment system according to claim 1, wherein the payment module is further configured to provoke the display of a link to an online payment site on a screen accessible to the buyer, together with the message containing the rules of execution.

9. The payment system according to claim 1, further comprising collecting collection device that collects the settlements and which makes an overall settlement for the product or service to the vendor or provider.

10. A method of payment for a product or service, for the settlement of a product or service by a number of settlements, for the implementation of a payment system according to claim 1, the method comprising:
presenting a purchaser with a selection of a product or service and transmission, to the payment module of said payment system, of information relating to the split payment for the product or service comprising the number of settlements planned for the payment for said product or service and the indication of the buyer or each buyer; and
transmitting, to the buyer or to each buyer, an electronic message containing rules for the execution of each settlement generated by the payment module.

11. The method according to claim 10 wherein the product or service is a ticket.
